(19) United States
(12) Patent Application Publication
(10) Pub. No.: US 2015/0227284 A1
(43) Pub. Date: Aug. 13, 2015

(54) MOVABLE BARRIER OPERATOR WITH REMOTE MONITORING CAPABILITIES

(71) Applicant: Viking Access Systems, LLC, Irvine, CA (US)

(72) Inventors: Ali Tehranchi, Irvine, CA (US); Daniel Perez, Irvine, CA (US); Pezhmon Karimi, IRVINE, CA (US)

(73) Assignee: Viking Access Systems, LLC, Irvine, CA (US)

(21) Appl. No.: 14/179,304

(22) Filed: Feb. 12, 2014

(51) Int. Cl. G06F 3/0481; G07C 9/00; G06F 3/0484

(52) U.S. Cl. CPC G06F 3/04817; G06F 3/04842; G07C 9/00174

(57) ABSTRACT

The present invention generally pertains to a diagnostic tool for a mobile device such as a smartphone or laptop, which helps a user to control, monitor, diagnose and troubleshoot a movable barrier operator. In an exemplary embodiment, software is downloadable by the user from their phone's service provider, or from an operator manufacturer's website. The software comprises a graphical user interface, which allows a user to execute various diagnostic and monitoring functions. The operator is configured with a network interface for communicating with the mobile device wirelessly. Such an interface may comprise Bluetooth, Wi-Fi, NFC or any other wireless communication available.

### TECHNICAL FIELD OF THE INVENTION

The present invention relates in general to a movable barrier operator with remote monitoring capabilities, and more specifically to a movable barrier operator that is configured with a wireless network interface for communication with a remote device. Software comprising a graphical user interface (GUI) may be provided to the remote device, which allows communication that enables a user with remote monitoring, diagnostic, and operator control capabilities.

### COPYRIGHT & TRADEMARK NOTICE

A portion of the disclosure of this patent application may contain material that is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

### BACKGROUND OF THE INVENTION

Typically, technicians in the movable barrier industry are required to perform certain maintenance and repairs on a movable barrier operator in the field. This responsibility requires each technician to perform tasks such as setting barrier limits, monitoring power diagnostics, or otherwise diagnosing and troubleshooting an operator's components. Often, technicians performing such regular maintenance or repairs must access operators by removing operator covers or housings. This can be time consuming, and requires technicians that are trained with the skill and know-how for inspecting or otherwise working on the equipment. Furthermore, in order to gain access to the internal components of operators in the field, technicians must also be trained to use various tools, such as voltmeters, amp-meters, ohmmeters and so forth, which are typically required to test and troubleshoot operator systems and system components.

Service providers, or installers, such as manufacturers and distributors of operators, must therefore spend time and other valuable resources in acquiring the necessary equipment to service operators in the field. Furthermore, installers must train personnel to service operators properly, including educating technicians with the required know-how of utilizing tools and instruments used to measure, calibrate and otherwise perform maintenance on the operators.

From a technician's point of view, the prior art also presents several problems. For example, with conventional systems, troubleshooting or providing maintenance is often a challenge in areas that experience undesirable weather conditions. Since regular troubleshooting and maintenance tasks typically require accessing operator components, weather conditions may affect accessibility to the components. For example, rain, snow, excessive heat, or very cold weather often makes servicing operators in the field difficult.

Therefore, there is a need in the art for a more efficient means of enabling installers with a more convenient manner in which to offer services to operators in the field. Furthermore, there is a need in the art for a more efficient means of enabling operator technicians, or operator users, with a more convenient manner in which to troubleshoot, repair, or provide regular maintenance to operators. It is to these ends that the present invention has been developed.

### BRIEF SUMMARY OF THE INVENTION

To minimize the limitations in the prior art, and to minimize other limitations that will be apparent upon reading and understanding the present specification, the present invention describes a movable barrier operator with remote monitoring capabilities, and more specifically a movable barrier operator that is configured with a controller adapted for wireless communication with a mobile device. A GUI may be provided for the mobile device, which allows communication that enables a user with remote monitoring, diagnostic, and control capabilities.

A movable barrier operator, in accordance with one embodiment of the present invention, comprises: a movable barrier operator that includes a wireless network interface; a motor configured to move a barrier; one or more sensors for generating one or more signals related to one or more parameters of the movable barrier operator; and a controller configured to receive the one or more signals from the one or more sensors, and transmit data concerning the one or more signals to a remote device via the wireless network interface. The controller is further configured to receive one or more signals from the remote device, and set the one or more parameters concerning the barrier based on the received signals from the remote device, wherein the data concerning the one or more sensors is displayed on the remote device via a graphical user interface.

A remote device for interacting with a movable barrier operator, in accordance with one embodiment of the present invention, comprises: a wireless network interface; a user interface; and a processor. The processor is configured to send a signal to a movable barrier operator via the wireless network interface for requesting a value of a parameter pertaining to the movable barrier operator, receive data from the movable barrier operator, via the wireless network interface, concerning the requested value of the parameter pertaining to the movable barrier operator, and provide the data to a user via the user interface. The processor is further configured to generate a command to alter the value of the parameter, and send the command with the altered value to the movable barrier operator, so that the operator may make the requested changes to the parameter.

A user interface for communicating with a movable barrier operator in accordance with one embodiment of the present invention comprises a computer usable medium having a readable program code embodied in the computer usable medium, the readable program code adapted to be executed to implement a method for monitoring a movable barrier system, the method comprising obtaining access to a controller situated in a movable barrier operator via a wireless network interface, wherein the controller is connected to one or more sensors for generating one or more signals related to one or more parameters of the movable barrier system; receiving one or more data packets from the controller, the data packets generated by the controller from the one or more signals related to the one or more parameters of the movable barrier system; generating one or more data objects associated with the data packets pertaining to the one or more parameters; and displaying the one or more data objects on a display of a remote device.

A method for providing a remote device with monitoring information pertaining to a movable barrier system, in accordance with one embodiment of the present invention, comprises: providing a remote device with wireless access to a controller situated in a movable barrier operator via a wireless network interface, wherein the controller is connected to one or more sensors for generating one or more signals related to one or more parameters of the movable barrier system; and broadcasting, via a wireless network, one or more data packets generated by the controller from the one or more signals related to the one or more parameters of the movable barrier system.

A system for monitoring and controlling a movable barrier, in accordance with yet another embodiment of the present invention, comprises: a wireless network; a movable barrier; a movable barrier operator mechanically coupled to the movable barrier; and a remote device for interacting with the movable barrier operator. The remote device further comprises: a first wireless network interface for communicating with the movable barrier operator via the wireless network; a graphical user interface; and a processor. The remote device's processor is configured to: send a signal to a movable barrier operator via the wireless network interface, requesting a value of one or more parameter pertaining to the movable barrier operator; receive data from the movable barrier operator, via the wireless network interface, concerning the requested value of the parameter pertaining to the movable barrier operator, and provide the data to a user via the user interface. The movable barrier operator further comprises: a second wireless network interface for communicating with the remote device via the wireless network; a motor configured to move the barrier; one or more sensors for generating one or more signals related to the one or more parameters of the movable barrier operator; and a controller configured to: receive the one or more signals from the one or more sensors, transmit data concerning the one or more signals to the remote device via the wireless network interface, receive one or more signals from the remote device, and set the one or more parameters concerning the barrier based on the received signals from the remote device, and generate a command in response to the signal from the remote device to alter the value of the one or more parameters.

It is an objective of the present invention to enable installers with a tool that will facilitate the efficient training of technicians for servicing operators in the field.

It is another objective of the present invention to provide technicians servicing operators with a tool to set, diagnose, and alter settings of operators without having to access physical components or interfere with operation of the movable barrier.

It is yet another objective of the present invention to provide technicians servicing operators with a tool to set, diagnose, and alter settings of operators without requiring traditional instruments used to monitor an operator's status or settings pertaining to associated parameters.

It is yet another objective of the present invention to provide a tool for performing diagnostic and maintenance functions by wirelessly communicating with the operator.

These and other advantages and features of the present invention are described herein with specificity so as to make the present invention understandable to one of ordinary skill in the art.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the present invention. Furthermore, elements that are known to be common and well understood to those in the industry are not depicted in order to provide a clear view of the various embodiments of the invention.

FIG. 1(a) depicts the components of a system in accordance with one embodiment of the present invention.

FIG. 1(b) depicts the components of a system in accordance with another embodiment the present invention.

FIG. 2 depicts the components of an operator, which has been configured to wirelessly communicate with a remote device, in accordance with an exemplary embodiment of the present invention.

FIG. 3(a) is a flowchart describing a process of communicating diagnostic data between an operator and a mobile device, in accordance with one embodiment of the present invention.

FIG. 3(b) is a flowchart of a method for providing a remote device with monitoring information pertaining to a movable barrier system, wherein the operator continuously broadcasts the information to, for example, client-devices of a system utilizing a client-server.

FIG. 4(a) depicts a remote device configured with a user interface in accordance with one embodiment of the present invention, showing a sample screenshot that includes an output comprising voltage monitoring information.

FIG. 4(b) depicts a remote device configured with a user interface in accordance with one embodiment of the present invention, showing a sample screenshot that includes an output comprising control signals for activating components of an operator.

FIG. 4(c) depicts a remote device configured with a user interface in accordance with one embodiment of the present invention, showing a sample screenshot that includes an output comprising indicators pertaining to the various components or accessories coupled to the operator.

FIG. 4(d) depicts a remote device configured with a user interface in accordance with one embodiment of the present invention, showing a sample screenshot that includes an output comprising a visual indicator of the operator system settings, which facilitates control of each setting.

FIG. 4(e) depicts a remote device configured with a user interface in accordance with one embodiment of the present invention, showing a sample screenshot that includes an output comprising a means of controlling one of the settings shown in FIG. 4(d).

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

In the following detailed description, a movable barrier operator may be any system that controls a barrier to an entry, an exit, or a view. The barrier could be a door for a small entity (i.e. a person), or a gate for a large entity (i.e. a vehicle), which may swing out, slide open, or roll upwards. The operator, which may move or operate the barrier from an open position to a closed position and vice-versa, may be controlled locally or remotely.

Generally, the present invention involves a user interface, for example, a graphical user interface (GUI) on a remote device, such as a touch-screen device that is configured to communicate wirelessly with a movable barrier operator. The user interface may be provided, for example, via a mobile device application downloadable to the user's laptop or smartphone. A user may be able to request the application from an installer such as the operator's manufacturer or a third-party service provider of applications for smartphones. Once the user arrives at a location in which the user is to perform monitoring or maintenance for an operator in the field, the user may request access to the operator via a network that has been configured to connect the user's device to the operator. This network may be a wireless internet connection such as Wi-Fi™, a near-field-communication (NFC) connection, or may be a wireless peer-to-peer connection such as a Bluetooth®-enabled connection between the remote device and the operator.

Additionally, the invention involves a movable barrier operator that is configured for broadcasting data packets containing pertinent system information such as system parameters and any other information that may be useful for monitoring the movable barrier system. The system information may be sent in data packets on a continuous basis so that a remote device equipped with the proper user interface may receive updated information about the system.

Once access is granted to the remote device, the user interface enables the user with remote monitoring, diagnostic, and control capabilities over the operator without requiring the user to physically access the operator components. More importantly, the user may access all diagnostic data and perform many required maintenance tasks via the user interface, without having to use additional instruments to troubleshoot the operator or interfere with operation of the movable barrier. Furthermore, the present invention provides a significant advantage to both users and service providers alike: the user with the user interface enabled device is not required to have the skill or technical background for using the instruments typically required to perform the various operator maintenance and troubleshooting tasks.

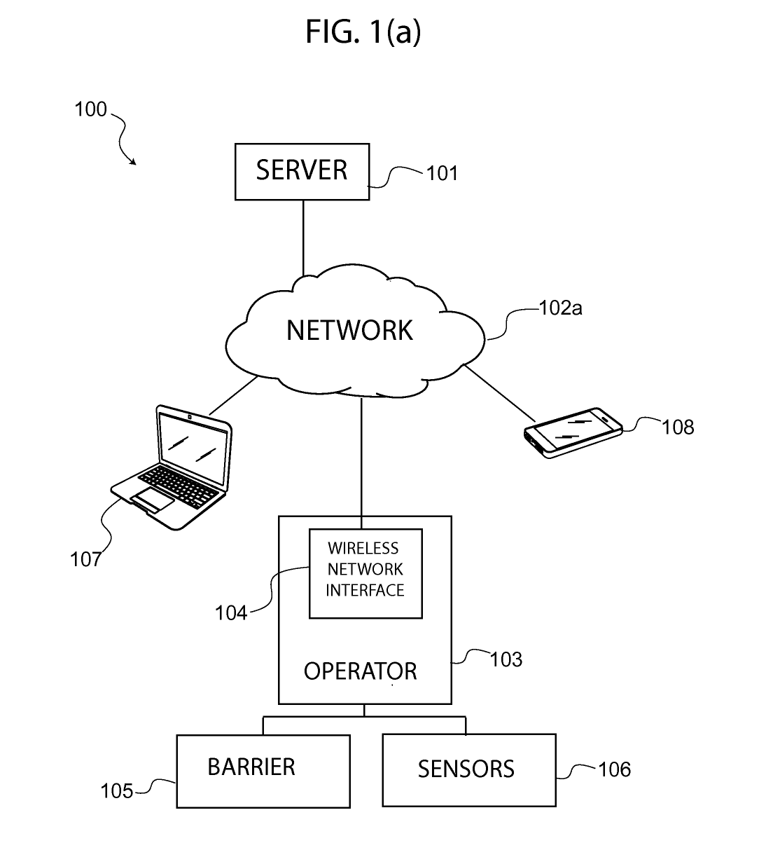

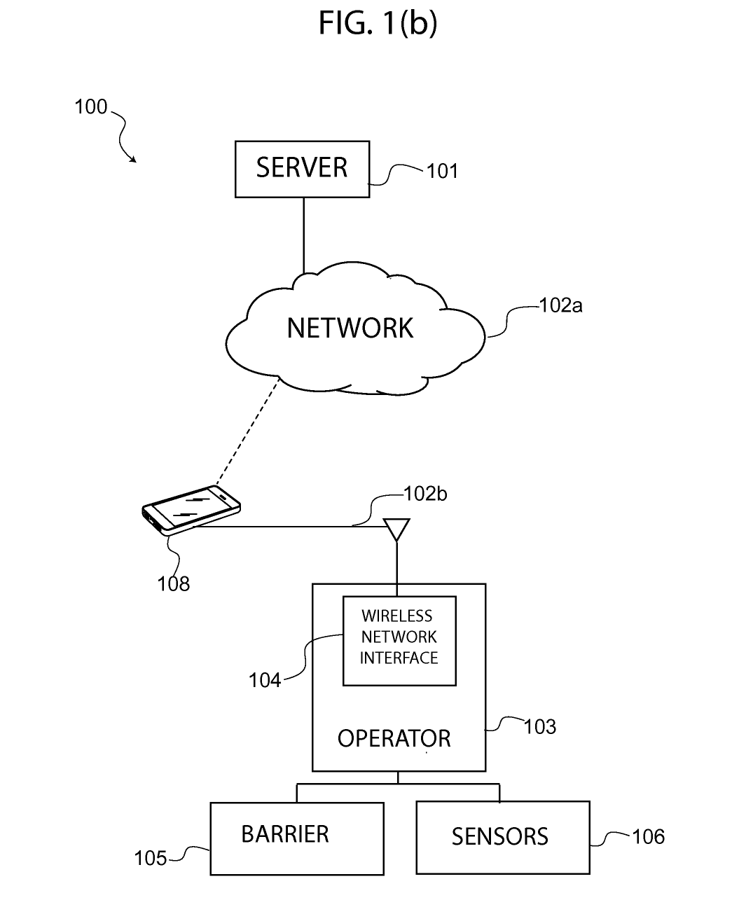

Turning now to the first figures of the drawings, FIG. 1(a) depicts the components of a system in accordance with one embodiment of the present invention, wherein the operator is configured to connect wirelessly to a network via a wireless network interface that, for example, uses Wi-Fi™. Similarly, FIG. 1(b) depicts the components of a system in accordance with another embodiment of the present invention, wherein the operator is not connected to a wide area wireless network such as the internet, but is configured to communicate directly with a user device via a peer-to-peer wireless network such as a Bluetooth®-enabled network or a local Wi-Fi™ network.

Rather than connect to a server via a common network between the operator and the user device, the user device may use its own wireless network to connect to a website or application service provider (e.g. Apple®'s App Store®) to download software comprising a user interface. Once the user has the software or application downloaded in his or her device, the user may proceed to move within range of the operator and connect with the operator by, for example, pairing with the operator or joining a common wireless network. The user may then access the operator and glean information pertaining to the system's components and parameters. Alternatively, the user may approach within range of the wireless connection, request access to the operator, and be given the option to download the software application required to access and review the operator components. Either way, once the user has a remote device configured with the required user interface or software, the user may then proceed with performing his or her tasks by utilizing the user interface, which may comprise a GUI included in the software.

System 100 comprises server 101, network 102a, and movable barrier operator (operator 103), which is configured with wireless network interface 104 to communicate with, control, and or change parameters for the operator and its components such as barrier 105 and sensors 106. System 100 may also comprise network 102b for communicating with a remote device that is located near operator 103.

In an exemplary embodiment, as shown in FIG. 1(b), a local network, such as peer-to-peer network 102b, may be utilized at the operator's physical location to provide communication between operator 103 and remote devices 107 and 108. Users, such as technicians or operator servicing agents, may utilize remote devices 107 and 108 to communicate with operator 103 via network 102b after having been provided with software from server 101 via network 102a. Alternatively, a client-server network may be utilized wherein operator 103 acts as the client device, broadcasting data packets related to the internal operational parameters of system 100. In such an embodiment, server 101 receives the data packets, stores it locally, and transmits it to other client devices such as remote devices 107 and 108.

Server 101 may be any server known in the art. For example, and without limiting the scope of the present invention, server 101 may be any system with software and suitable computer hardware that responds to requests across network 102a to provide user devices with an application or software for communicating with operator 103. Server 101 may be run on a single dedicated computer, or multiple computers, so long as it is configured to adequately provide users with support, such as software applications for communicating with operators in the field.

In one embodiment, server 101 is a server owned and operated by the same manufacturer as the manufacturer and distributer of operator 103. In such embodiment, server 101 may comprise a user interface, which is provided on a website associated with the manufacturer of operator 103. Users of operator 103 may visit the site and request access to the required software for communicating with operator 103.

In an exemplary embodiment, server 101 is a third-party server, which the manufacturer of operator 103 has employed or contracted to distribute and provide users of operator 103 with the required software for communicating with operator 103. For example, and without limiting the scope of the present invention, server 101 may be an Apple® owned server which may be accessed via Apple®'s App Store® by a user utilizing an iPhone®.

Network 102a may be any kind of network known in the art, including a wireless network configured to connect to a server via the internet. For example, and without limiting or deviating from the scope of the present invention, network 102a comprises a wireless network connected to the internet, for example a Wi-Fi™-enabled network or a cellular data wireless network. In this way, a technician within range of the wireless network, may request access to the operator and be given the option to download the software application required to access and review the operator components. Once the user has downloaded the required software or application, the user may proceed with performing his or her tasks by utilizing a user interface included in the software—for example, a touch-screen enabled GUI.

Network 102b is typically a local wireless network that utilizes decentralized and distributed network architecture such as a peer-to-peer network. In an exemplary embodiment, system 100 utilizes a network as shown in FIG. 1(b) as the means for communicating between operator 103 and remote device 108, once remote device 108 has obtained the proper software for communicating with operator 103.

Operator 103 may be any machine or system that controls the movement of movable barrier 105. Operator 103 may move barrier 105 to its open position, its closed position, or to any position in between. Operator 103 may also start or stop movement of barrier 105 at any point along the movement track of barrier 105. In one embodiment, movable barrier 105 is a horizontally sliding gate and operator 103 may control the horizontal sliding motion of barrier 103. In another exemplary embodiment, where movable barrier 105 is an upward swinging garage door, operator 103 may control the pivot swinging motion of movable barrier 105.

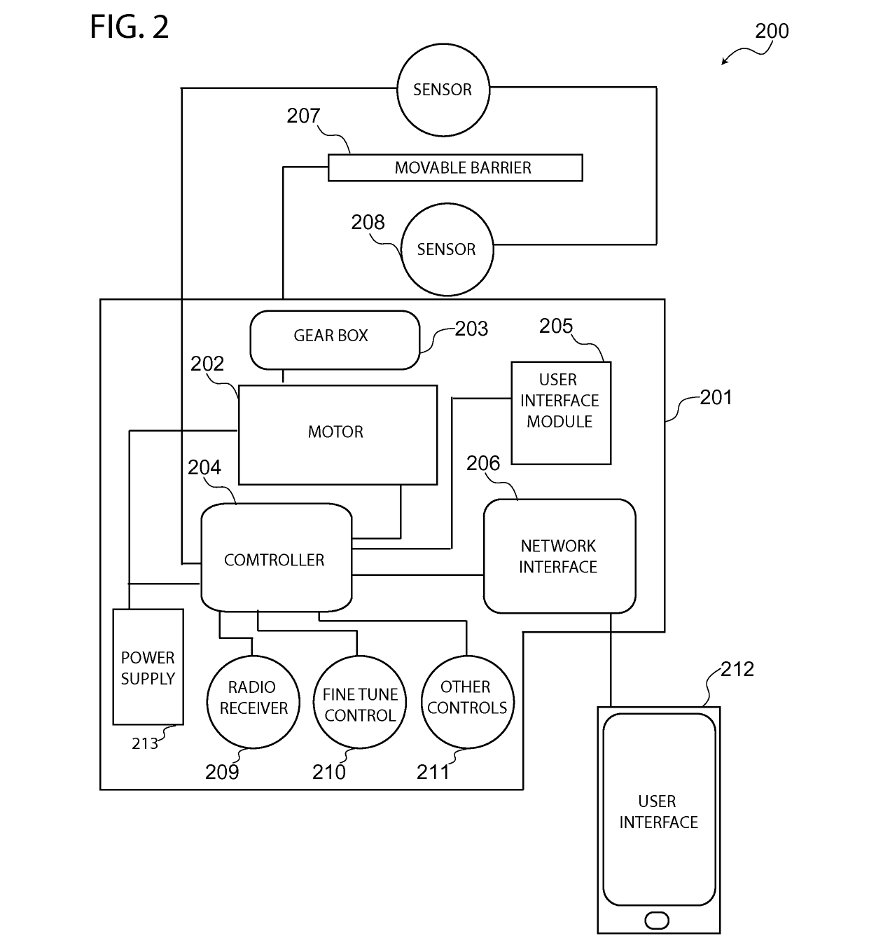

Operator 103 may comprise typical components such as a motor, a gear box, and a controller for generating the required signals pertaining to the operation of one or more barriers or movable barrier subsystems that may be controlled by operator 103. Although not shown in FIG. 1, these components of an operator in accordance with the present invention will be discussed in more detail below with reference to FIG. 2. Additionally, operator 103 further comprises of wireless network interface 104.

Wireless network interface 104 may be any type of wireless interface configured for a network such as network 102a or 102b. Wireless network interface 104 may be configured for decentralized and distributed network architecture such as a peer-to-peer network. Wireless network interface 104 provides the communication channel in which information such as packetized data is shared amongst the interconnected devices, for example packetized data communicated between operator 103 and remote device 108. In an exemplary embodiment, wireless network interface 104 may utilize the Bluetooth® wireless protocol, although other similar means of communication may be achieved without deviating from the scope of the present invention.

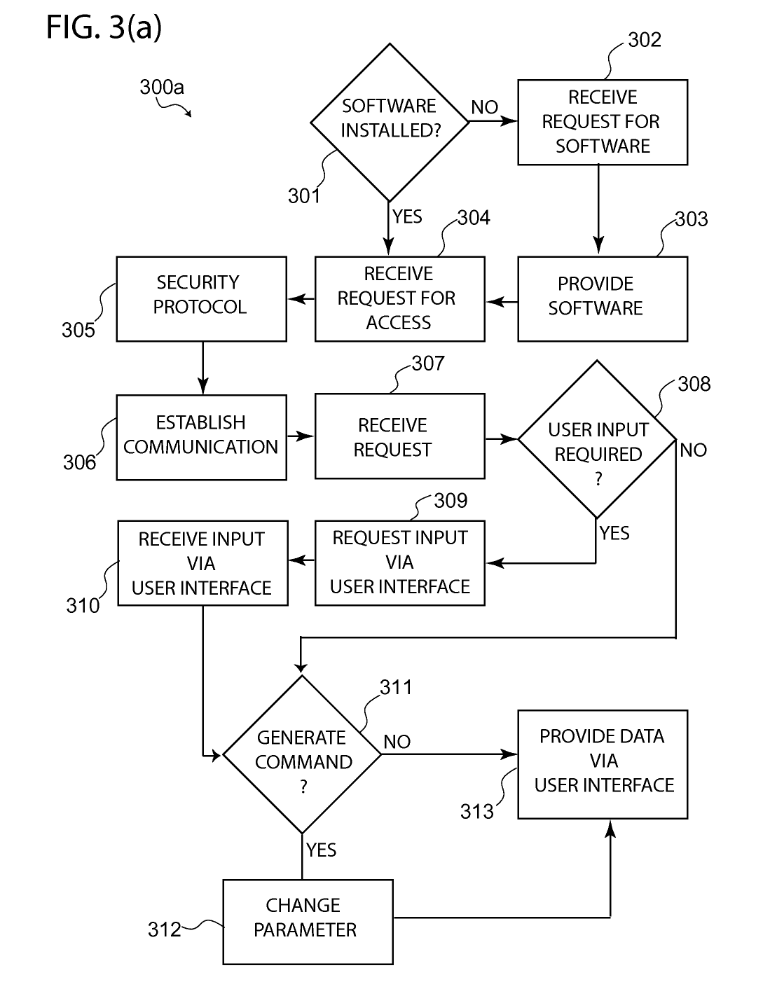

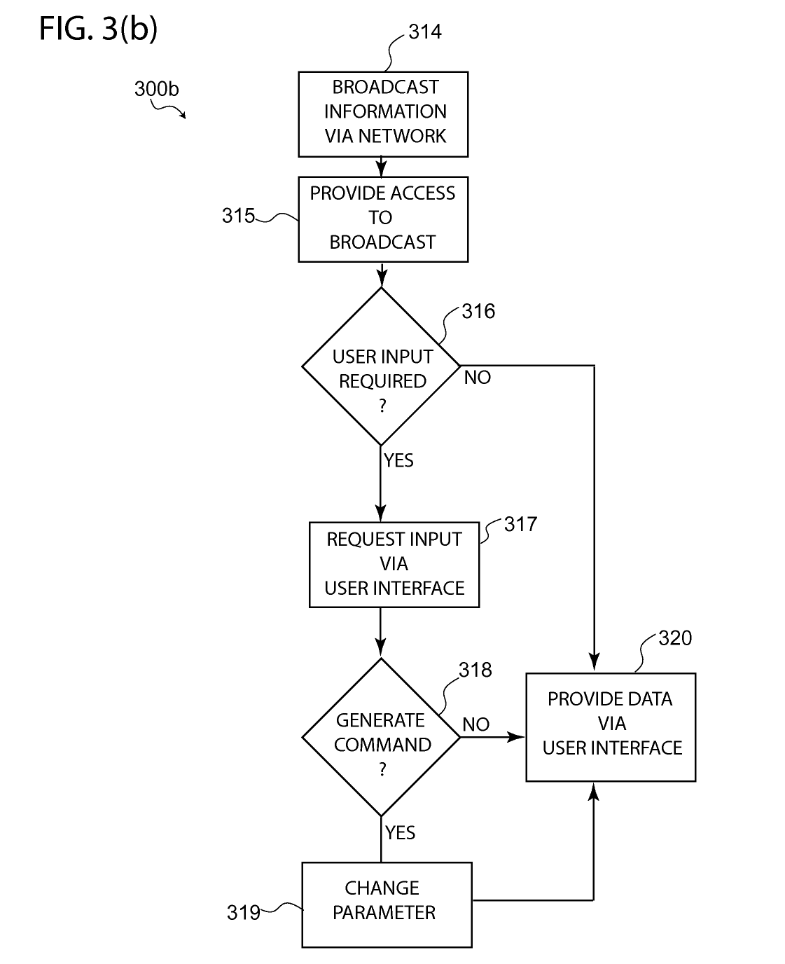

Wireless network interface 104 may be designed for short range data transmissions between operator 103 and remote devices 107 and 108. Wireless network interface 104 may be adapted to transmit data, including signals for generating commands from operator 103 to remote devices 107 and 108. Furthermore, wireless network interface 104 allows operator 103 to transmit diagnostic information pertaining to system 100's settings, status, and parameters associated with the system, to remote devices 107 and 108. This connectivity to operator 103 permits easy access for a user, especially when manual access to system 100 may be difficult or impractical. The interface, and the data that may be specifically communicated between operator 103 and a user device enabled with a user interface in accordance with the present invention, will be discussed in greater detail below with reference to FIG. 3.

Additionally, wireless interface 104 may be one or more components that enable operator 103 to communicate with either server 101 via network 102a, or remote device 108 via network 102b, or both the server and the remote device. Hence, wireless interface 104 may enable operator 103 to connect to both the server and remote devices. Furthermore, it may be desirable for operator 103 to utilize one network for some communication, and another network for other communications.

For example, and without limiting or deviating from the scope of the present invention, in an exemplary embodiment, operator 103 may be configured to communicate both via network 102a and 102b. In such embodiment, operator 103 may use network 102a for certain communications, and reserve network 102b for other communications; operator 103 may communicate with server 101 via network 102a in order to obtain necessary software, or to provide software to a remote device. Furthermore, operator 103 may utilize network 102a to obtain firmware updates from server 101, or provide updates to a remote device. On the other hand, operator 103 may reserve network 102b for communicating data pertaining to an operator status, system parameters, or any other monitoring or diagnostic information that may be communicated between operator 103 and a remote device within range of network 102b. In such embodiment, operator 103 may therefore use network 102b for broadcasting data packets pertaining to the operator's settings, system parameters, and any other monitoring or diagnostic information.

The broadcasting of data packets may be continuous, or performed on predetermined intervals, or may be executed upon requests from one or more remote devices connected to the network in which operator 103 is broadcasting information. For example, and without deviating or limiting the scope for the present invention, operator 103 may continuously broadcast data packets containing monitoring or diagnostic information via network 102a, by continuously updating server 101 with data pertaining to the system's parameters, settings, or any other information pertaining to system 100. Alternatively, operator 103 may continuously broadcast this information only via network 102b so that only a remote device within range of network 102b (and with access to the required user interface) may obtain this information. Furthermore, operator 103 may simply broadcast information pertaining to system 100 only upon a request, either via remote device 107 accessing operator 103 via network 102a, or by a user locally situated, and equipped with remote device 108 accessing operator 103 via network 102b.

The remaining components of system 100 comprise of components that are in one way or another connected to operator 103. These include, without limitation, barrier 105 and sensors 106.

Barrier 105 is typically mechanically connected to operator 103, for example via a gear box that provides for movement of barrier 105 when a motor within operator 103 is actuated. Barrier 105 may be any type of barrier, as stated above, without limiting or deviating from the scope of the present invention. In an exemplary embodiment, barrier 105 is a gate to a structure that may be slid or swung open or close.

Sensors 106 are typically electronically connected to operator 103 and provide a variety of information pertaining to system 100. Sensors 106 may comprise of sensors pertaining to external components or internal components of operator 103. For example, and without limiting or deviating from the scope of the present invention, sensors 106 may comprise of obstruction sensors, loop-induction sensors, or any other type of sensors adapted for generating a signal to either stop or actuate movement of barrier 105 to, for example, indicate that a vehicle is approaching barrier 105 and that barrier 105 should stay open. However, sensors 106 typically also comprise of other types of sensors that include internal sensors pertaining to the operator's internal components. For example, and without limiting or deviating from the scope of the present invention, sensors 106 may include surge protection sensors, voltage sensors, current sensors, amperage sensors, or any other type of internal sensor that may provide status or diagnostic information pertaining to system 100. Utilizing several types of sensors throughout system 100 will facilitate the system to function properly and information that is gathered from sensors 106 by operator 103 may be communicated via wireless network interface 104 to a user with a user interface-enabled remote device such as remote devices 107 and 108.

Remote devices 107 and 108 may be any number of devices known in the art. Typically, remote devices 107 and 108 may be a laptop or a smartphone. However, remote devices 107 and 108 may be any type of mobile device with the required specifications capable of providing a user interface for communicating data from operator 103 and its components, to the user or users operating the remote devices. Of course, each of remote devices 107 and 108 may be enabled with a user interface by requesting that software or an application be delivered to each device. Additionally, each device may be capable of connecting wirelessly utilizing a protocol compatible with wireless network interface 104.

This type of wireless access to the operator components provides a more convenient way of setting, monitoring, diagnosing and troubleshooting an operator. The user interface may comprise a GUI on a remote device such as a mobile phone or personal computer that utilizes touch-screen technology. The GUI may be a component of software, which may be downloaded on the mobile device. The GUI may be configured for allowing the user to wirelessly perform tasks such as creating desired settings for system 100 components, checking a status for system 100 components, or performing maintenance or troubleshooting tasks. Most importantly, these tasks may be performed without requiring the technician to physically access or otherwise manually service the operator.

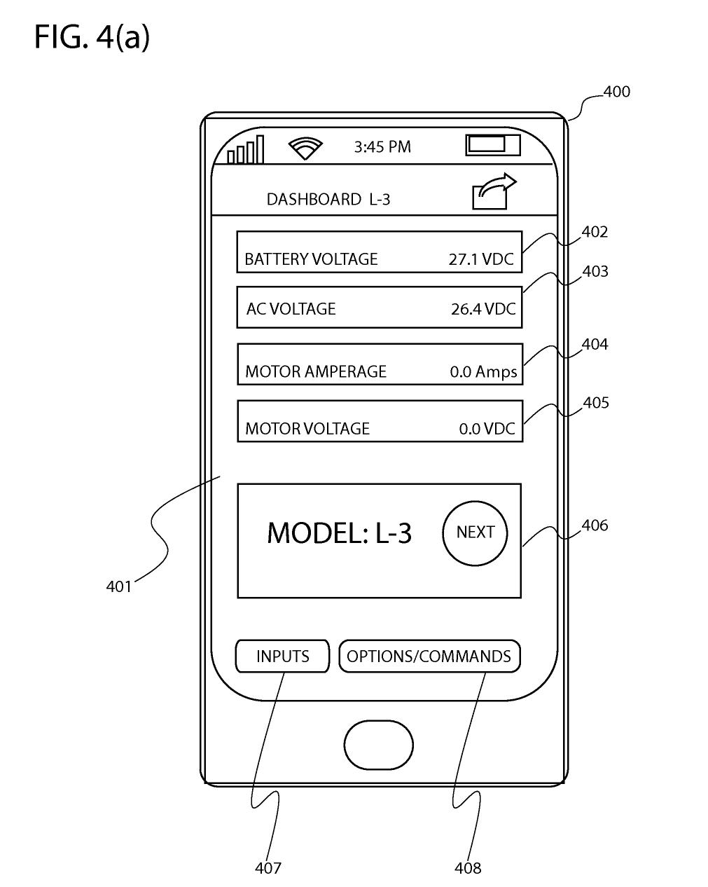

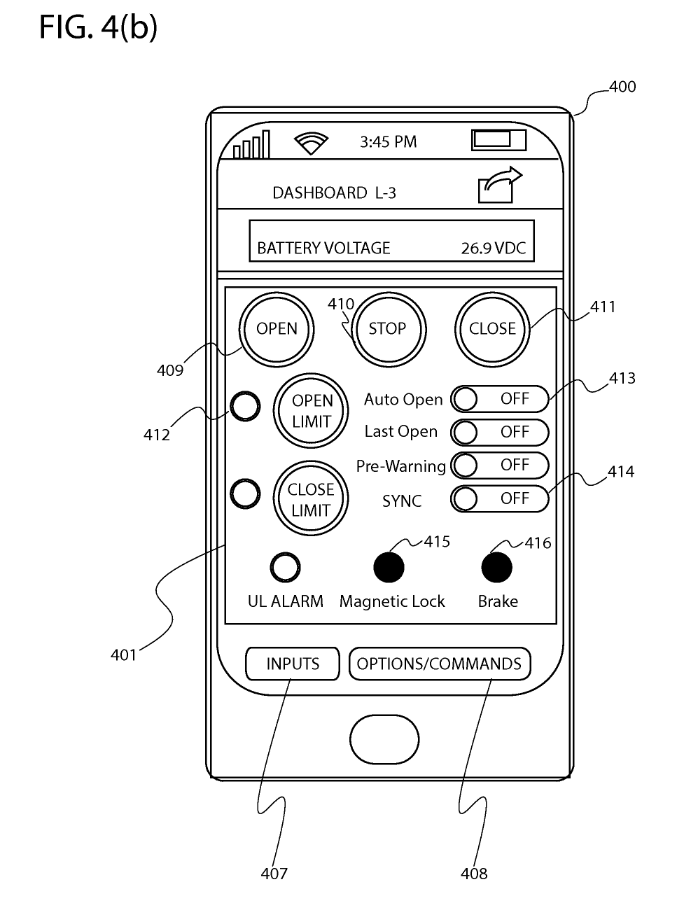

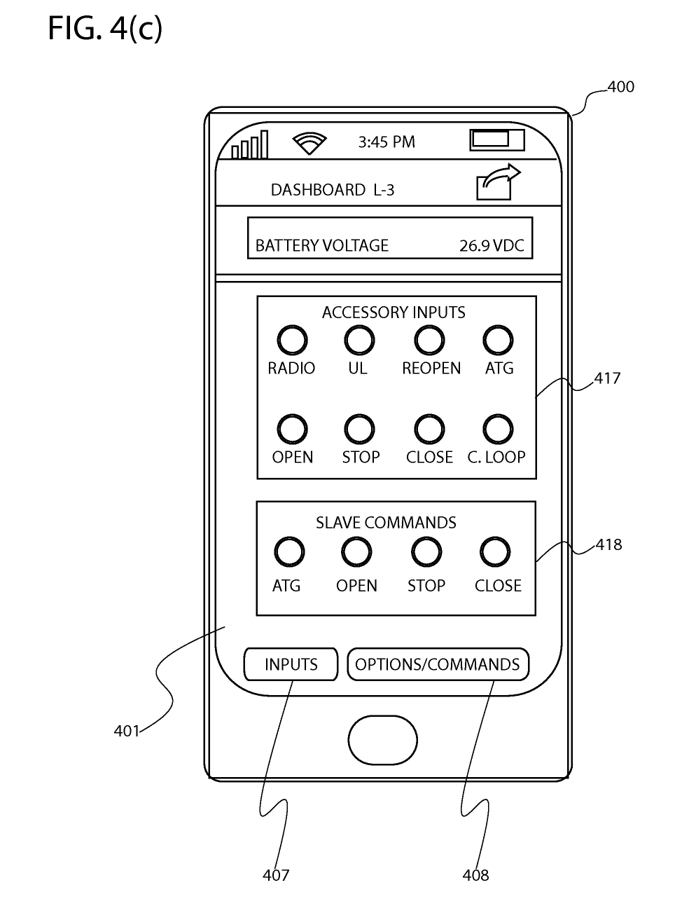

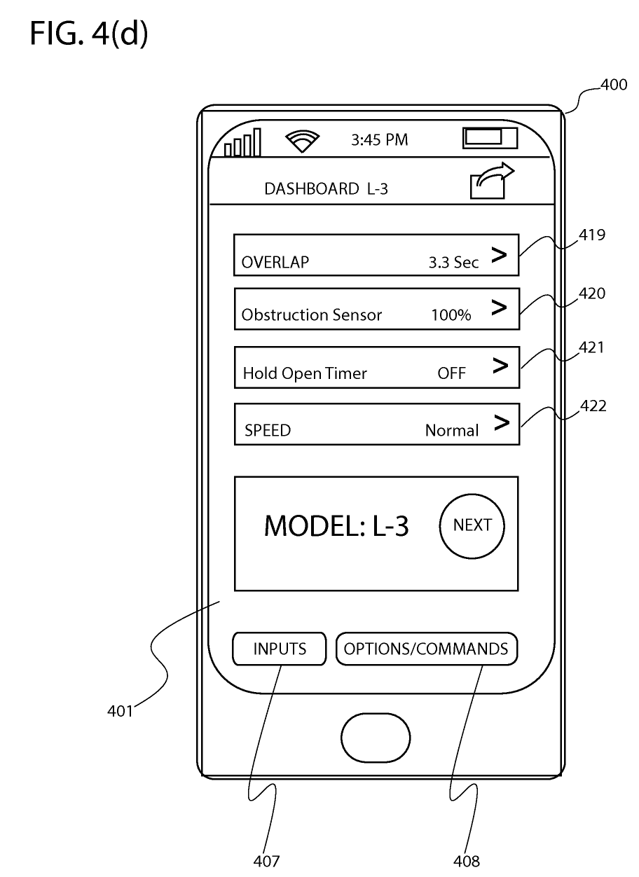

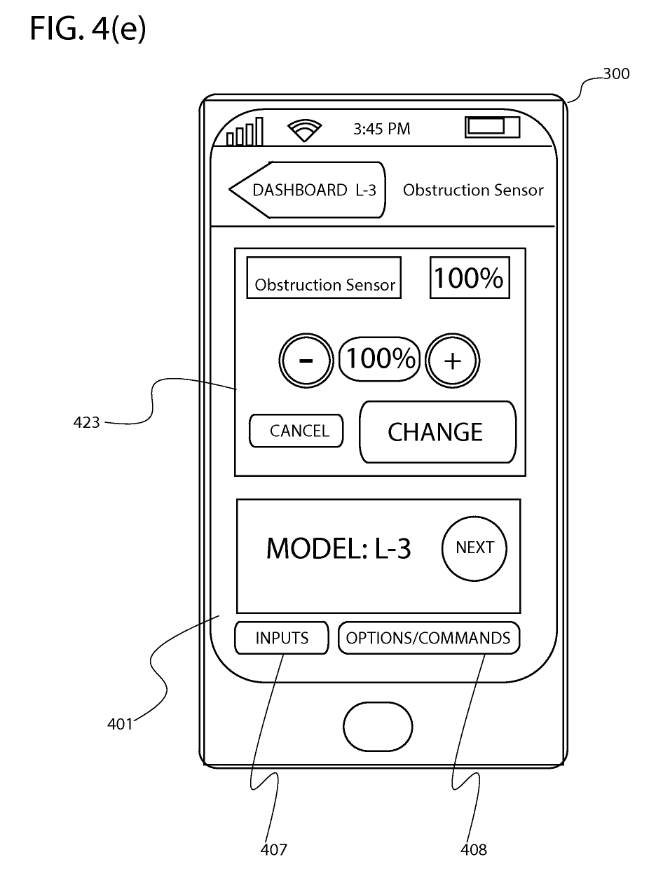

For example, the technician will not have to perform tasks such as removing a cover or housing to operator 103; if measurements of parameters are required, the technician will not have to know where to measure, how to measure, or even be equipped with the proper equipment typically required to make such measurements. Similarly, the technician will not have to be trained to know what knobs or switches to set to execute a particular function. The software will provide a simple to use GUI, which allows a technician with minimal training to perform the required tasks. Furthermore, the technician will also have the added luxury of being able to perform any required functions or diagnostic check-ups, from the comfort of his car or service shack or any other area designated for servicing the operator, without having to access the operator itself. Details regarding the functionality of a user interface in accordance with the present invention are discussed with reference to FIG. 4(a)-FIG. 4(d).

Turning now to the next figure of the drawings, FIG. 2 depicts the components of a movable barrier operator system in accordance with one embodiment of the present invention. System 200 is shown with the following components: movable barrier operator (operator 201), which further comprises motor 202, gearbox 203, controller 204, user interface 205 and wireless network interface 206; all typically powered by a power supply 213, which may be a battery or any other type of well known power supply device for powering an operator and its various components.

As is typically the case, motor 202 is coupled to gearbox 203, which in turn is mechanically coupled to barrier 207 and moves barrier 207 after receiving a command signal from controller 204. An important component housed within the operator housing is wireless network interface 206, which may be any kind of communication interface that allows the operator to connect to remote device 212. In one embodiment, this interface may be a modem for connecting to a LAN or Wi-Fi™. In another embodiment, this interface comprises a wireless interface that utilizes the Bluetooth® protocol to communicate with remote device 212.

System 200 may comprise of several devices such as different types of sensors, fine control modules, and many other devices typically used in the field. System 200 includes obstruction sensors 208, radio receiver 209, fine tune control module 210, and other devices 211. Other devices 211 may comprise one or more internal sensors for providing data pertaining to a system status, such as surge protection sensors, voltage and amperage readers, and any other device that may provide useful information pertaining to a system status or parameter. Furthermore, other devices may include other types of components such as loop detection devices, a master/slave communication unit, or a hold open timer. Note, however, that system 200 may be connected to fewer or additional compatible components without limiting the scope of the present inventions.

In order to receive, send, and transmit signals or data, or to generate commands from received signals or data, movable barrier operator 201 should include controller 204. In the present embodiment, controller 204 is connected to all internal and external components of movable barrier system 200.

Controller 204 governs the functionality of movable barrier system 200 and the interactivity of its sub-components. All data inputs from connected components or devices are relayed to controller 204. For example, should radio receiver 209 receive a signal to open barrier 207, radio receiver 209 would then send a corresponding data input to controller 204. Additionally, command instructions received by wireless network interface 206 are relayed to controller 204.

After receiving signals or data inputs from connected external devices, including remote device 212, the signal received, or the data received via wireless network interface 206 is interpreted by controller 204 and either a command is generated or an output data may be provided. Thus, controller 204 may receive information and transmit instructions to the various components of movable barrier system 200.

For example, and without limiting the scope of the present invention, in response to a command instruction received via wireless network interface 206, controller 204 may perform diagnostic tests on the components of system 200. Thus, controller 204 may test and gather information pertaining to the functionality of all the components of system 200. Depending on the signal, data or command instructions relayed to controller 204 in a transmission received from remote device 212 via wireless network interface 206, controller 204 may perform specific diagnostic tests, perform an entire system diagnostic, may simply output data pertaining to one or more parameters associated with system 200, may generate a command signal for controlling a component of system 200, or may set a parameter value for one or more components of system 200.

For example, and without limiting or deviating from the scope of the present invention, should a user with a user interface enabled user device, such as remote device 212, send a command instructing system 200 to provide a voltage output for motor 202, controller 204 would read the information provided via, for example, a voltage output sensor, and provide that information to the user by transmitting the data via wireless network interface 206. Remote device 212 would receive the data and provide an output via the user interface that was provided to the user as explained above with reference to FIG. 1(a) and FIG. 1(b).

Hence, controller 204 may provide remote device 212 with any information that it is able to receive from its various components. For example, fine tune control module 210 may be a device that controls the movement limits of movable barrier 207. When movable barrier 207 nears the limit of its predetermined track, fine tune control module 210 may send a signal to controller 204 to command motor 202 to stop movement. Controller 204 may provide this information to remote device 212, and additionally, may also receive an input from a user to change a setting pertaining to the limit value associated with fine tune control module 210. In this manner, a user may now access and control settings for devices such as fine control module 210 that is connected to operator 201.

Operator 201 may therefore transmit data, for example packetized data, comprising information pertaining to a status of one or more components of system 200. Similarly, via a user interface that may be downloaded on remote device 212, remote device 212 may transmit user command instructions to operator 201 via wireless network interface 206 of system 200. The transmitted data may include, without limitation, data pertaining to a status of system 200 components, diagnostic information pertaining to system 200, and one or more parameters pertaining to one or more components of system 200.

The commands transmitted by remote device 212 to operator 201 may include a request for diagnostic tests on specific devices, a request for diagnostic information on all system parts and functions, or even a request to set one or more parameter values pertaining to one or more system components. Remote device 212 may transmit changes or alterations to system settings for system 200, or may include control instructions to movable barrier operator 201 to perform on barrier 207. Control instructions include commands to open, close, and to start or stop movement of barrier 207, or any other command directed at altering or setting a parameter of system 200.

Diagnostic information may include the results of diagnostic tests performed by system 200 on its various subcomponents and externally connected devices. Similarly, data that pertains to a system status or a component parameter may include, without limitation, a motor load, application voltage, acceleration rate, barrier movement speed, battery voltage, charger status, hold open timer, obstruction sensitivity, fine tune control settings, and any other data that may be generated by system 200 components.

Other components not shown in FIG. 2 but that may nonetheless make up system 200 may include movable barrier subsystems such as slave operators controlled by operator 201. Such slave operators may control access to a location by being mechanically coupled to additional movable barriers. For example, in one embodiment, operator 201 is a master operator and is configured to control at least one other operator coupled to another gate in the same warehouse. Thus, a technician with access to operator 201 may glean diagnostic data and even set controls and parameters for the slave operator which is in communication with operator 201.

A technician with access to remote device 212 may therefore access information pertaining to each component via a user interface-enabled mobile device that has been provided with the proper software to communicate with operator 201.

FIG. 3(a) is a flow chart outlining a process of communicating diagnostic data between an operator and a mobile device, in accordance with one embodiment of the present invention. Specifically, FIG. 3(a) illustrates a flow chart of method 300a for providing a user with information pertaining to a movable operator system. The method is employed by and between a controller and a remote device, which has been enabled with a user interface for communicating with a movable barrier operator. Method 300a is explained in the order shown below; however, the following steps may be taken in any other conceivable sequence without deviating from the scope of the present invention.

A user may approach an operator with a wireless interface in accordance with the present invention. The user may be for example, a technician desiring to access information pertaining to a movable barrier operator system in the field. In one embodiment, prior to even accessing the operator, the user will have to have the software required for accessing the desired system. While in some embodiments a user may be able to simply approach the operator and request to be paired with the operator, in an exemplary embodiment, the user will be required to have the user interface on their remote device in order to be enabled with connectivity.

In step 301, the user will determine whether the required user interface is installed or requires installation on the remote device he or she will use to access the system. If the remote device has been provided with the required software or user interface installed, step 304 will follow. Alternatively, if the device lacks the user interface, then in step 302, the remote device may connect to a network. In step 303, the service provider may provide downloadable software that includes a user interface, such as a GUI, for performing the desired tasks. This may be the same network for communicating with the movable barrier operator system, or may be a different network such as a wireless phone network with access to the internet (see FIG. 1(a) and FIG. 1(b)).

In step 304, the operator's controller may receive an access request via a wireless network interface, and in step 305 a security protocol may be enabled to prevent undesirable users from accessing the system. In step 306, communication is established and the system is ready to receive and send data.

Once access is granted, the user interface may be displayed and the remote device may provide visual outputs for the user to glean information pertaining to the system. In exemplary embodiments, the user interface may comprise of a touch screen enabled interface, for requesting access to components of the system, such as obstruction sensors—for example, to control sensor sensitivity. While some features may simply require the user to view and glean information from their device's screen, other features may implement options for the user to input information, such as setting sensitivity levels, travel limits, or other parameters that may need to be set and transmitted back to the operator in order for the operator to complete the task at hand.

In an exemplary embodiment of the present invention, a GUI is provided via a mobile device application, such as a smartphone. A user is able to request the application from a service provider and download it to his or her device. Once the user arrives at a location in which the user is to perform monitoring or maintenance for an operator in the field, the user may request access to the operator via a network that has been configured to connect the operator to the user's device. Once access is granted to the user, the GUI enables the user with remote monitoring, diagnostic, and control capabilities over the operator at the user's location. More importantly, the user may access all diagnostic data and perform any required maintenance tasks, via the GUI, without having to physically access the operator or interfere with operation of any movable barrier.

In step 307, the controller receives a request from the user via a wireless network interface. The request may be for a desired output or for a desired command to change a setting or to control or actuate a component of the movable barrier system. In the latter case, the user may be required to provide additional information such as a value for a setting, such as an obstruction sensitivity level, a travel limit distance, a travel limit angle, or any other parameter associated with one or more components of the system.

Therefore, in step 308, it may be determined whether an additional user input is required or whether an output or command may be generated in response to the request. If an additional input is required, then in step 309, the request for the user input is provided to the user via the user interface. In step 310, the user provides the required input and that input is further communicated to the controller via the wireless interface.

In step 311, a determination may be made on whether the user input will require an output of information pertaining to the system, or will require a command to one or more system components. If a command for a system component is desired, then in step 312, the controller may generate and send the generated command to the one or more system components. Finally, in step 313, the user may be provided with the output of the desired information or resulting state after changing the parameter. Alternatively, if in step 311, a determination is made that the user has only made a request pertaining to an output, and that there is no need to generate a command, the desired data may likewise be provided in step 313.

For example, and without limiting the scope of the present invention, a user may request information pertaining to a system status such as whether surge protection is working properly; alternatively, a user may request information pertaining to a system parameter such as battery voltage, AC voltage, motor amperage, motor voltage or any other parameter pertaining to the system and its components. With either of these requests, the controller would receive the request from the remote device, and read the desired data from the associated device. The controller might make a determination as to whether a user input is required, and since the user has only requested an output of the information, then in step 310 the information may be sent to the remote device via the wireless interface.

In an exemplary embodiment of the present invention, the user device may enable the following setting functions or parameters: hold open timer setting (i.e. off, on, or a particular length of time to close the barrier); obstruction sensitivity (i.e. the sensitivity for detecting an obstruction); overlap delay (i.e. synchronization time with tandem barriers such as other gates controlled by slave operators); pre-warning times (i.e. a time to sound a beacon before starting movement of a barrier); barrier travel limits (i.e. opened position limits and closed position limits for the barrier); speed (i.e. how quickly the barrier opens, closes, or otherwise moves); enable or disable automatic functions in case of power failure (i.e. functions such as an auto-open function that automatically opens the gate, or a pre-warning function that automatically sets off a beacon/alarm, or any other automated function that depends on sensors automatically actuating one or more system components); enable or disable automatic functions when alternative power sources are implemented into a system; enable or disable security functions; enable or disable synchronization modes to other barrier operators within a premises; enable and set timers (i.e. to hold-open a gate for a specified amount of time); or set recording modes of historical data from the barrier operator (i.e. past data that has been recorded pertaining to system settings or parameters, or pertaining to past diagnostic tests and maintenance). These and other features and functions, or parameters, may be monitored, and controlled via the user interface.

Furthermore, in an exemplary embodiment of the present invention, the user interface, via a GUI, may enable the user to visualize (numerically or graphically) some or all parameters of an operator without utilizing the equipment typically required to perform these tasks. For example, a visual representation may be provided for: AC voltage; charging voltage; battery voltage; motor voltage; motor current; and barrier operator internal voltages. Of course, other features and functions, or parameters, pertaining to the system may be implemented without limiting or deviating from the scope of the present invention. This feature may be desirable because utilizing graphical representations does not require a user to know how to use the equipment or instruments that are traditionally utilized to obtain the readings. Hence, the user need not be skilled or have the required know-how to service the operators by having access to these monitoring and troubleshooting capabilities. For example, rather than require a user to measure power levels, the user interface can show a battery image that displays whether the system has a full charge—similar to a user reading the battery level on their smartphone.

Therefore, a GUI in accordance with the present invention may enable users to troubleshoot an operator by facilitating access to important elements without requiring the user to know where these elements are located in the system, or even how to check them. For example, and without limiting the scope of the present invention, the user may be supplied with the following information via a GUI installed in a mobile device: fuse status; voltage level; surge protection status; errors detected on a sensor attached to the barrier; errors detected on essential components of the barrier operator; status of various devices and connections to the barrier; and any other type of indicator pertaining to the operator or movable barrier system.

Additionally, other more basic information about the system may be provided to users via the GUI. For example, some basic information about the system could include: an operator model identifier; a user manual associated with the operator model; and any other basic information about the movable barrier operator system.

Additionally, the GUI could supply other supplemental information and related functions such as: allowing the user to link and retrieve specification sheets associated with the operator model; allowing the user to link and retrieve architectural specifications for a particular premises; allowing the user to link and retrieve images and brochures as instructional material to service the operator; and any other type of supplemental information that may be provided to a user.

In addition to information that may aid a user in monitoring an operator, other functionalities may be implemented such as: allowing a user to execute an automatic self-diagnostic routine; providing an email or text to upload the results to a second technician or central office; allowing the user to send an instant text message to a tech support service, or allowing the user to be directed to a tech support line. Of course, other features and functions pertaining to facilitating a user with monitoring and troubleshooting an operator may be implemented without limiting or deviating from the scope of the present invention.

As stated above, the operator may be configured for continuously broadcasting data packets containing monitoring information about the system. FIG. 3(b) is a flowchart of method 300b for providing a remote device with monitoring information pertaining to a movable barrier system, wherein the operator continuously broadcasts the information to, for example, client-devices of a system utilizing a client-server. Method 300b is explained in the order shown below; however, the following steps may be taken in any other conceivable sequence without deviating from the scope of the present invention.

In step 314 of method 300b, information pertaining to a movable barrier system is broadcasted via a wireless network. This may be accomplished in any number of ways without deviating or limiting the scope of the present invention. For example, a controller situated in a movable barrier operator may generate one or more data packets from one or more signals it receives from the various system sensors. These signals, and thereby the data packets, pertain to one or more parameters of the movable barrier system. As mentioned above, these parameters may include, without limitation: settings, functions, monitoring information, diagnostic information, or any other information pertaining to the movable barrier system. The data packets may then be broadcast by either continuous means or on predetermined intervals. Alternatively, broadcasting may be executed upon requests from one or more remote devices connected to the network in which the operator is broadcasting information.

In one embodiment, an operator may continuously broadcast data packets containing monitoring or diagnostic information via a client-server network by continuously updating the server with data pertaining to the system's parameters, settings, or any other information pertaining to the system. Alternatively, the operator may continuously broadcast this information via a local wireless network such as a Wi-Fi network that only a remote device within range of may access to obtain the information. Once information is being broadcast, or an operator is properly configured to broadcast data upon request, a remote device with access to the network wherein the information is being broadcast, may access the desired system information.

In step 315, the installer may provide remote devices with wireless access to a controller situated in a movable barrier operator. This may be accomplished in any number of ways without deviating from the scope of the present invention. For example, and without limitation, the installer may provide a remote device with software, such as a smartphone application. The application may be downloaded from a server owned by the installer, or from a third-party server.

Once installed, the installer may provide users of the software with any security protocol desired to prevent unwanted access to the movable barrier system information. A user may then approach a wireless network wherein the information is being broadcast, and have access to the system information on their remote device so that once the application is executed, the application will obtain access to the broadcast information and be enabled for communication with the controller of the movable barrier operator. In some embodiments of the present invention the information need not be continuously broadcast throughout a network, however, one of the advantages of continuous broadcasting may be that the system information is continuously up to date. A user with access via a remote device need only look at their screen to view the most recent parameter values associated with the entire system. Hence, the user will instantly know at what speed the barrier is set to open or close, which automated functions are enabled (if any), at what voltage and at what current the motor or other components are running, the level of obstruction sensitivity for a particular sensor, and any other pertinent system information.

Once the information is being broadcast and the remote device has access to the various system parameters, in step 316, a determination may be made of whether the remote device necessitates information for which a user input is required. For example, while the present voltage supplied to the motor may be provided instantly to the remote device via the broadcast information, if the user wishes to turn on a function, or change a particular setting, then user input may be required. If no user input is required, because for example the user desires only to check whether a function is enabled—the user need only look at the remote device for information, and proceed to step 320 where the information is provided. On the other hand, if the user desires to actually enable or disable the function, in step 317, the user interface may provide a request via a screen for inputting the desired information—for example display a virtual on/off switch to enable/disable the desired function.

In step 318, a determination may be made on whether an additional command may be required. For example, if the user input in step 317 comprises of a change in a parameter such as obstruction level sensitivity, once the user input (i.e. the new desired sensitivity level) is received by the controller at the movable barrier operator, the operator may send a signal changing the requested parameter in step 319.

In an exemplary embodiment, after changing or altering the value for a parameter, the updated information is broadcast, and hence in step 320, the updated information is provided via the user interface on the remote device by providing updated data concerning the one or more parameters the user has altered.

Turning to the remaining figures, FIG. 4(a) depicts a remote device configured with a user interface in accordance with one embodiment of the present invention, showing a sample screen-shot that includes an output comprising voltage monitoring information. More specifically, FIG. 4(a) depicts remote device 400, which a user may connect to a wireless network and use to communicate with a movable barrier system in accordance with the present invention. Software may be provided to remote device 400, which includes user interface 401. User interface 401 may provide system status or system parameters via user interface 401, such as by displaying tabs with information provided by an operator's controller. Different tabs may display different parameters. As shown, tab 402 displays a value for a parameter pertaining to the battery voltage of the operator; tab 403 displays a value for a parameter pertaining to an AC voltage; tab 404 displays a value for a parameter pertaining to a motor amperage; and tab 405 displays a value for a parameter pertaining to the motor voltage in real time.

Depending on the tasks that a user may be required to perform, user interface 401 may provide an interface for facilitating inputs, such as input button 407, or configuring options or generating commands via button 408. For example, selecting input button 407 or options/commands button 408 may take the user to a list page where several inputs or commands are provided.

FIG. 4(b) depicts a remote device configured with a user interface in accordance with one embodiment of the present invention, showing a sample screenshot that includes an output comprising control signals for activating components of an operator. More specifically, if a user desires to enable or disable components of a movable barrier system, user interface 401 may provide options to generate such commands.

For example, user interface 401 may provide a virtual open switch 409 or stop switch 410, or close switch 411 for controlling the movement of a barrier. Setting controls may include virtual switches for activating or deactivating features such as auto-open features, pre-warning features, or any other feature that may be desirable to enable or disable remotely. Indicators may also be desirable such as virtual LED indicator 412, which may indicate whether an open limit or a close limit is activated. For example, in the shown embodiment, a magnetic lock and brake have been activated and thus virtual LED indicators 415 and 416 appear “lit” to the user. Similarly, virtual “buttons” may be provided to turn on or off a particular function such as auto-open function 413 or sync function 414. Naturally, various other “buttons,” “tabs,” or input data objects may be provided in a GUI depending on the desired functionality and complexity of the operator system.

FIG. 4(c) depicts a remote device configured with a user interface in accordance with one embodiment of the present invention, showing a sample screenshot that includes an output comprising indicators pertaining to various components coupled to the operator. More specifically, FIG. 4(c) shows one screen that may be provided by user interface 401 in which a visual representation of the activated accessory inputs and slave commands are provided to a user. Accessory inputs refer to movable barrier components, and slave commands refer to commands for slave operators and their components. For example, accessory inputs window 417 may be provided to show a user the accessory functions that have been enabled or disabled or whether they are functioning properly or even activated. Similarly, slave command output 418 may also be provided to show a user any commands that have been enabled or for slave subsystems such as a slave operator(s) controlling access to alternative entrances, exits, or doorways in the same premises.

FIG. 4(d) depicts a remote device configured with a user interface in accordance with one embodiment of the present invention, showing a sample screenshot that includes an output comprising a visual indicator of the operator system settings, which facilitates control of each setting. More specifically, the screen shown provides a user with tabs 419, 420, 421, and 422, all of which take the user to another screen pertaining to the indicated parameter. For example, pressing tab 420 would take a user to the screen shown in FIG. 4(e).

FIG. 4(e) shows a sample screenshot that includes an output comprising a means of controlling one of the settings shown in FIG. 4(d). Just as the setting for the obstruction sensor may be selected to provide a user input, other various settings that require user inputs may be accessed via the GUI, and thereby controlled remotely from the user device. Therefore, selecting tab 420 takes the user to a screen that includes window 423. Window 423 provides a user with an output indicator associated with the requested parameter or function, in this case the level of sensitivity for a particular obstruction sensor. Furthermore, window 423 also provides input buttons to control the obstruction sensitivity level. It should be noted that a user device in accordance with the present invention may include various graphical representations to enable different types of functions. For example, in one embodiment, the display may provide a graphical representation of a potentiometer for enabling the user to control potentiometer-enabled components of the system. Furthermore, the user interface may provide the user with buttons, levers, turn dials, or any other means of providing user control of user inputs.

In an exemplary embodiment of the present invention, user interface 401 is provided via a mobile device application, such as a smartphone. A user is able to request the application from an installer and download it to his or her device. Once the user arrives at a location in which the user is to perform monitoring or maintenance for an operator in the field, the user may request access to the operator via a network that has been configured to connect the operator with the user's device. Once access is granted to the user, the user interface, which comprises a GUI, enables the user with remote monitoring, diagnostic, and control capabilities over the operator at the user's location. More importantly, the user may access all diagnostic data and perform any required maintenance tasks, via the GUI, without having to physically access the operator or interfere with operation of any movable barrier.

A movable barrier operator with remote monitoring capabilities has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

What is claimed is:

1. A user interface, comprising a computer usable medium having a readable program code embodied in the computer usable medium, the readable program code adapted to be executed to implement a method for monitoring a movable barrier system, the method comprising:
obtaining access to a controller situated in a movable barrier operator via a wireless network interface, wherein the controller is connected to one or more sensors for generating one or more signals related to one or more parameters of the movable barrier system;
receiving one or more data packets from the controller, the data packets generated by the controller from the one or more signals related to the one or more parameters of the movable barrier system;
generating one or more data objects associated with the data packets pertaining to the one or more parameters; and
displaying the one or more data objects on a display of a remote device.

2. The user interface of claim 1, wherein the executed method for monitoring the movable barrier system further comprises:
receiving a user input for altering a value pertaining to the one or more parameters; and
generating a command signal for commanding the controller of the movable barrier operator to change the one or more parameters of the movable barrier system according to the user input.

3. The user interface of claim 2, wherein displaying the one or more data objects on a display of a remote device comprises:
displaying a user manual for performing maintenance of the movable barrier system.

4. The user interface of claim 2, wherein displaying the one or more data objects on a display of a remote device comprises:
providing one or more windows comprising one or more virtual LED indicators associated with one or more accessory inputs.

5. The user interface of claim 2, wherein displaying the one or more data objects on a display of a remote device comprises:
providing one or more windows comprising one or more virtual LED indicators associated with one or more slave components of the movable barrier system.

6. The user interface of claim 2, wherein displaying the one or more data objects on a display of a remote device comprises:
providing one or more tabs for displaying one or more values pertaining to the one or more parameters of the movable barrier system.

7. The user interface of claim 6, wherein the one or more tabs comprise of a user selectable data object for displaying a new window and requesting a user input to alter the one or more values pertaining to the one or more parameters of the movable barrier system.

8. The user interface of claim 1, wherein the executed method for monitoring the movable barrier system further comprises:
updating a firmware for the controller in response to a request initiated from the remote device via the wireless network interface.

9. The user interface of claim 1, wherein the executed method for monitoring the movable barrier system further comprises:
executing an automatic diagnostic test of the movable barrier system in response to a request initiated from the remote device via the wireless network interface.

10. The user interface of claim 9, wherein displaying the one or more data objects on a display of the remote device comprises:
displaying the results of the automatic diagnostic test of the movable barrier system.

11. The user interface of claim 9, wherein the executed method for monitoring the movable barrier system further comprises:
enabling a communication containing the results of the automatic diagnostic test between the movable barrier operator and a remote user.

12. The user interface of claim 7, wherein the one or more parameters of the movable barrier system comprise of a voltage indicator concerning one or more components of the movable barrier operator.

13. The user interface of claim 7, wherein the one or more parameters of the movable barrier system comprise of a current indicator concerning one or more components of the movable barrier operator.

14. A movable barrier operator, comprising:
a wireless network interface;
a motor configured to move a barrier;
one or more sensors for generating one or more signals related to one or more parameters of the movable barrier operator; and
a controller, configured to:
receive the one or more signals from the one or more sensors, and
transmit data concerning the one or more signals to a remote device via the wireless network interface.

15. The movable barrier operator from claim 14, wherein the controller is further configured to receive one or more signals from the remote device, and alter the one or more parameters concerning the movable barrier operator based on the received signals from the remote device.

16. The movable barrier operator from claim 15, wherein the controller is further configured to update a firmware for the controller in response to a request initiated from the remote device via the wireless network interface.

17. The movable barrier operator from claim 15, wherein the controller is further configured to execute an automatic diagnostic test of the movable barrier system in response to a request initiated from the remote device via the wireless network interface.

18. The movable barrier operator from claim 15, wherein the controller is further configured to enable a communication containing the results of the automatic diagnostic test between the movable barrier operator and a remote user.

19. The movable barrier operator from claim 15, wherein the data concerning the one or more sensors is displayed on the remote device via a graphical user interface.

20. The movable barrier operator from claim 16, wherein the one or more parameters concerning the movable barrier operator that are set by the controller comprise an obstruction sensor sensitivity level.

21. The movable barrier operator from claim 16, wherein the generated signals related to the one or more parameters comprises a voltage indicator concerning one or more components of the movable barrier operator.

22. The movable barrier operator from claim 16, wherein the generated signals related to the one or more parameters comprises a current indicator concerning one or more components of the movable barrier operator.

23. A remote device for interacting with a movable barrier operator, comprising:
a wireless network interface;
a user interface; and
a processor configured to:
send a signal to a movable barrier operator, via the wireless network interface, requesting a value of a parameter pertaining to the movable barrier operator,
receive data from the movable barrier operator, via the wireless network interface, concerning the requested value of the parameter pertaining to the movable barrier operator, and
provide the data to a user via the user interface.

24. The remote device of claim 23, wherein the processor is further configured to generate a command to alter the value of the parameter, and send the command with the altered value to the movable barrier operator.

25. The remote device of claim 23, wherein the processor is further configured to generate a command to update a firmware for the movable barrier operator in response to a request initiated from the remote device via the wireless network interface.

26. The remote device of claim 23, wherein the processor is further configured to execute an automatic diagnostic test of the movable barrier operator in response to a request initiated from the remote device via the wireless network interface.

27. The remote device of claim 26, wherein the processor is further configured to enable a communication containing the results of the automatic diagnostic test between the movable barrier operator and a remote user.

28. The remote device of claim 23, wherein the parameter pertaining to the movable barrier operator comprises an obstruction sensor sensitivity level.

29. The remote device of claim 23, wherein the parameter pertaining to the movable barrier operator comprises a voltage indicator concerning one or more components of the movable barrier operator.

30. The remote device of claim 23, wherein the parameter pertaining to the movable barrier operator comprises a current indicator concerning one or more components of the movable barrier operator.

31. The remote device of claim 24, wherein the command to the movable barrier operator comprises an obstruction sensor sensitivity level.

32. The remote device of claim 24, wherein the command to the movable barrier operator comprises a movement speed for a barrier controlled by the movable barrier operator.

33. The remote device of claim 24, wherein the command to the movable barrier operator comprises a travel limit for the barrier.

34. A method for providing a remote device with monitoring information pertaining to a movable barrier system, comprising:
providing a remote device with wireless access to a controller situated in a movable barrier operator via a wireless network interface, wherein the controller is connected to one or more sensors for generating one or more signals related to one or more parameters of the movable barrier system; and
broadcasting, via a wireless network, one or more data packets generated by the controller from the one or more signals related to the one or more parameters of the movable barrier system.

35. The method of claim 34, further comprising:
receiving, from the remote device, one or more requests for altering a value pertaining to the one or more parameters of the movable barrier system; and
generating a command signal to alter the one or more parameters of the movable barrier system based on the one or more requests for altering the value pertaining to the one or more parameters of the movable barrier system.

36. The method of claim 35, further comprising:
providing an updated data concerning the one or more parameters that were altered in response to the request received from the remote device, for displaying the updated data via a graphical user interface residing on the remote device.

37. The method of claim 36, further comprising:
updating a firmware for the controller in response to a request initiated from the remote device via the wireless network interface.

38. The method of claim 36, further comprising:
executing an automatic diagnostic test of the movable barrier system in response to a request initiated from the remote device via the wireless network interface.

39. The method of claim 38, further comprising:
displaying the results of the automatic diagnostic test of the movable barrier system.

40. The method of claim 39, further comprising:
enabling a communication containing the results of the automatic diagnostic test between the movable barrier operator and a remote user.

41. The method of claim 36, further comprising:
providing a user manual via the graphical user interface of the remote device to aid the user in performing maintenance on the movable barrier system.

42. The method of claim 36, wherein the one or more parameters pertaining to the movable barrier system comprise a voltage indicator concerning one or more components of the movable barrier system.

43. The method of claim 36, wherein the one or more parameters pertaining to the movable barrier system comprise an amperage indicator concerning one or more components of the movable barrier operator.

44. The method of claim 36, further comprising:
enabling a communication between a user of the remote device and an installer via the graphical user interface to aid the user in performing maintenance on the movable barrier system.
